(19) United States
(12) Patent Application Publication
(10) Pub. No.: US 2007/0095332 A1
(43) Pub. Date: May 3, 2007

(54) Fuel supply device

(75) Inventor: Yusaku Sakai, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/402,966

(22) Filed: Apr. 13, 2006

(30) Foreign Application Priority Data
Nov. 1, 2005 (JP) P2005-318288

(51) Int. Cl. F02M 37/04

(52) U.S. Cl. 123/509

(57) ABSTRACT

A fuel supply device includes a bracket provided at an opening of a fuel tank so as to form a blockage, for being arranged with a discharge pipe; a fuel pump mounted to the bracket, for suctioning fuel in the fuel tank and discharging fuel from the discharge pipe; and a fuel level detector for detecting the remaining amount of fuel in the fuel tank. The fuel supply device further includes a holder for holding the fuel level detector, the holder being formed of an elastically deformable material and mounted on the bracket; and the fuel level detector is held at any position.

### BACKGROUND OF THE INVENTION

1. Field of the Invention

The present invention relates to an in-tank type fuel supply device in which a fuel pump is arranged in a fuel tank and, more particularly, to a mounting structure of a fuel level detector which detects the amount of fuel in the fuel tank.

2. Description of the Related Art

In a known in-tank type fuel supply device, when a little fuel remains in a fuel tank, a thermistor serving as a fuel level detector is arranged in the fuel tank in order to inform an operator of this matter. This thermistor is joined by brazing to a thermistor holder which is fixed to a shaft by brazing or the like; further, the shaft is fixed to a stay, which extends from a bracket, with screws or the like directly or via an other fixing member.

Meanwhile, a minus side terminal is electrically connected via the thermistor holder, shaft, and stay, realizing what is termed a grounded state, as disclosed in Japanese Unexamined Patent Application Publication No. 2000-297715, for example (refer to page 4, from the 19th-line to 35th-line in the right column, and FIG. 9).

The known fuel supply device is configured as described above; thereby causing an increase in cost due to the increase in the number of components required for mounting the thermistor and in the number of working man-hours required for processes such as brazing and screw mounting.

Furthermore, there are problems in that individual component preparation to the request of changing mounting height interferes with the acceleration of standardization; and since the thermistor is supported at one side, it is susceptible to vibrations when a shaft for fixing the thermistor is long.

### SUMMARY OF THE INVENTION

The present invention has been made to solve the aforementioned problems of the known device, and an object of the present invention is to provide an inexpensive, high-reliability fuel supply device with a decreased number of components and improved workability. Another object of the present invention is to provide a fuel supply device that can adapt readily and promptly, and can detect the remaining amount of fuel with high accuracy, without replacing with other components when the mounting height of the thermistor is changed.

According to the present invention, there is provided a fuel supply device including: a bracket attached to an opening of a fuel tank, for being arranged with a discharge pipe; a fuel pump mounted to the bracket, for suctioning fuel in the fuel tank and discharging fuel from the discharge pipe; and a fuel level detector for detecting the remaining amount of fuel in the fuel tank, the fuel supply device further including: a holder for holding the fuel level detector, the holder being formed of an elastically deformable material and mounted on the bracket, and wherein the fuel level detector is held at any position.

Furthermore, according to the present invention, there is provided a fuel supply device including a filter case or a fuel pump holding member mounted to a bracket, on which a plurality of the holders for holding a fuel level detector are formed so that the fuel level detector is held at a plurality of positions at different elevations.

According to the fuel supply device of the present invention, an inexpensive, high-reliability fuel supply device with good productivity may be obtained.

Furthermore, according to the fuel supply device of the present invention, the fuel supply device can adapt readily and promptly when amounting height of a fuel level detector is changed and accuracy for detecting the remaining amount of fuel may be enhanced.

### BRIEF DESCRIPTION OF THE DRAWINGS

FIG. 1 is an outline view showing a fuel supply device according to a first embodiment of the present invention;

FIG. 2 is an enlarged perspective view showing a thermistor and a holder of the fuel supply device according to the first embodiment. of the present invention;

FIG. 3 is a transverse sectional view showing the holder according to the first embodiment of the present invention;

FIG. 4 is an outline view showing a fuel supply device according to a second embodiment of the present invention; and

FIG. 5 is an outline view showing a fuel supply device according to a third embodiment of the present invention.

### DESCRIPTION OF THE PREFERRED EMBODIMENTS

First Embodiment

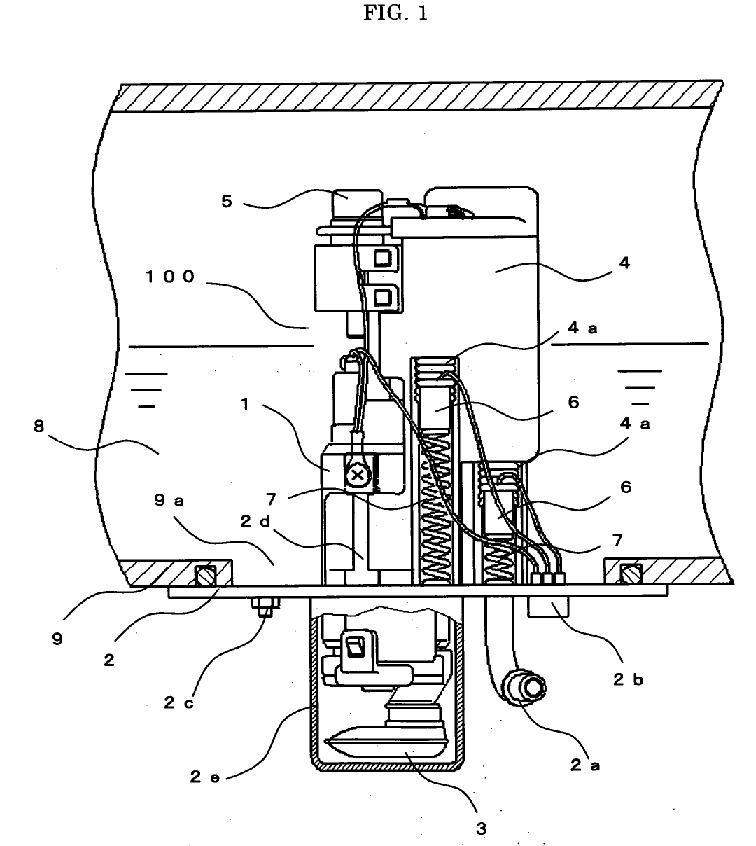

A first embodiment of the present invention will be described below with reference to FIG. 1 to FIG. 3.

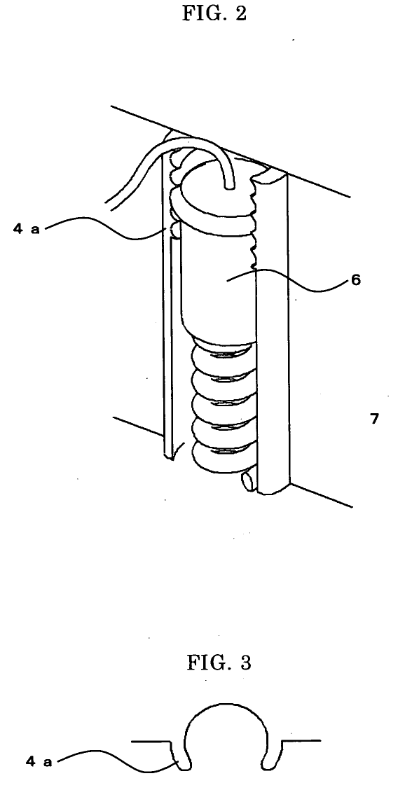

FIG. 1 is an outline view showing a fuel supply device according to the first embodiment of the present invention; FIG. 2 is an enlarged perspective view of a thermistor and a holder shown in FIG. 1; and FIG. 3 is a transverse sectional view of the holder shown in FIG. 1.

In FIG. 1, a fuel supply device 100 includes a fuel pump 1 which suctions fuel 8 in a fuel tank 9 and discharges; a metal bracket 2 provided at an opening 9a of the fuel tank 9 so as to form a blockage; an inlet filter.3 which prevents foreign particles from entering into the fuel pump 1 by trapping foreign particles contained in the fuel 8; a resin filter case 4 which incorporates a filter for eliminating further foreign particles remaining in the fuel discharged from the fuel pump 1; a pressure regulator 5 which is mounted to the filter case 4 and adjusts fuel to be discharged via a discharge pipe 2a to be described later, to a predetermined pressure; a thermistor 6 serving as a fuel level detector which is attached to a holder 4a provided at the filter case 4 and detects the remaining amount of fuel 8; and a spring 7 which becomes a part of a minus side electrical path of the thermistor 6.

The metal bracket 2 will be further described in detail. The bracket 2 includes the discharge pipe 2a which is attached to an internal combustion engine of a vehicle not shown in the figure and from which fuel 8 to be compressively delivered to an injector or the like is discharged; a power supply terminal 2b for supplying power to the fuel pump 1 and thermistor 6 from a battery attached to the vehicle also not shown in the figure; a grounding terminal 2c; and a stay 2d for holding the filter case 4. The bracket 2 further includes a chamber 2e for retaining the fuel 8 around the fuel pump 1 in order to stably supply fuel even when the vehicle is being driven along a sloping road or the body itself is being shaken. The holder 4a for holding the thermistor 6, as shown in FIG. 2 and FIG. 3, is formed of an elastically deformable material, for example, a resin material, with substantially a channel-shaped cross section. The thermistor 6 is fixed by the elastical deformation of the holder 4a and therefore, for example, the thermistor 6 does not bounce due to vehicle vibrations and can be held with high reliability; and the thermistor 6 can be readily attached or detached from the holder 4a.

Furthermore, as is apparent from FIG. 1, the holder 4a is formed by disposing a plurality of numbers, thereby enabling the position (height) of the thermistor 6 to be arbitrarily adjusted and, more particularly, enhancing a following capability of detecting the remaining amount of fuel 8 according to the shape of the fuel tank 9, whereby it is configured so that the holder 4a can be readily and promptly adapted to the change in the disposed position (height) of the thermistor 6 along with the aforementioned configuration capable of allowing the thermister 6 to be readily attached or detached.

Further, as shown in FIG. 1, the spring 7 is placed between the thermistor 6 and the bracket 2 and the thus obtained configuration enables conductivity of the minus side of the thermistor 6 to be ensured, that is, the minus side terminal of the thermistor 6 can be lead to the grounding terminal 2c via the spring 7 and bracket 2. Consequently, contact defects due to soldering and screws need not be taken into account together with assembling work becomes easy, resulting in further increased reliability.

In addition, in the first embodiment, when considered from the viewpoint of the following capability of detecting the aforementioned remaining amount of fuel 8, for example, as shown in FIG. 1, the holder 4a is provided with a plurality of numbers while giving different elevations, whereby the remaining amount of fuel 18 is monitored by a plurality (two, in this case) of the thermistors 6; therefore, it is needless to say that accuracy of detecting the remaining amount of fuel 8 is enhanced.

Still, in this embodiment, although the holder 4a is attached to the filter case 4, it is not limited to this configuration; for example, in the case where the filter for eliminating further foreign particles remaining in the fuel is arranged outside the fuel tank 9 (that is, in the case where the filter case 4 is not provided), the holder may be attached to a fuel pump holding member for holding the fuel pump 1 and the same effects can be obtained.

Further, for example, if the holder 4a is formed of a conductive resin material and is lead to the grounding terminal 2c via the holder 4a itself, the aforementioned spring 7 can be omitted. As described above, according to the fuel supply device of the first embodiment of the present invention, the holder for holding the thermistor serving as the fuel level detector is formed of an elastically deformable material with a channel-shaped cross-section; the holder is mounted on the bracket integrally with the filter case, fuel pump holding member, and the like; and the fuel level detector is held at a plurality of any different positions (heights), whereby a high-reliability fuel supply device which is good in terms of productivity, and is inexpensive and vibration proof can be obtained.

Furthermore, when a mounting height of the fuel level detector is changed, the fuel level detector can be readily and promptly adapted and accuracy for detecting the remaining amount of fuel can be enhanced.

Second Embodiment

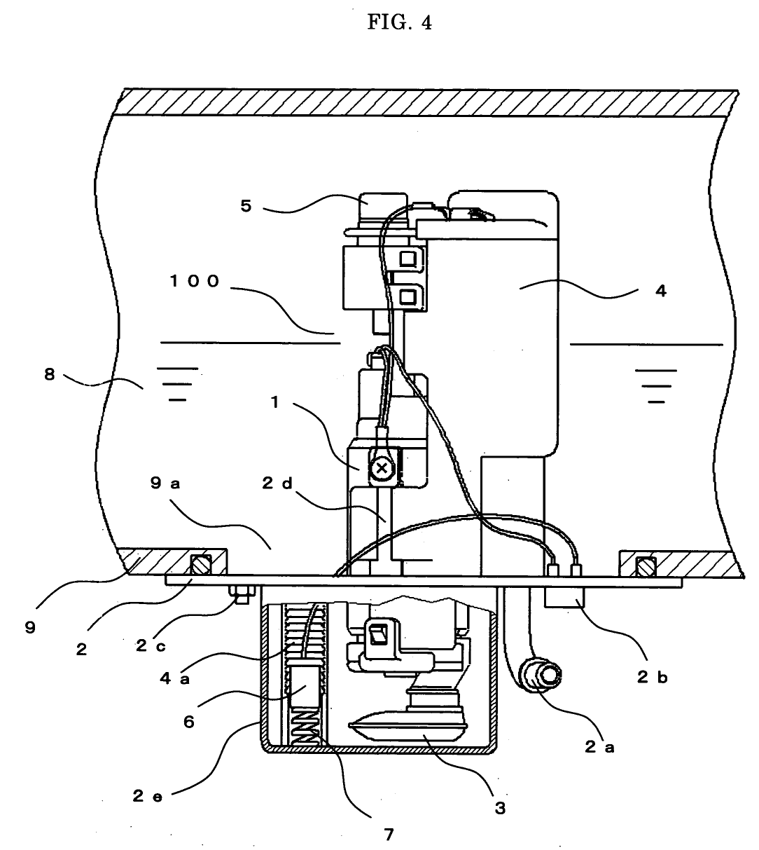

A second embodiment of the present invention will be described with reference to FIG. 4.

FIG. 4 is an outline view showing a fuel supply device according to the second embodiment of the present invention. In addition, referring to the drawing, the same reference numerals as those shown in FIG. 1 represent the same or-corresponding elements and their description will be omitted.

In FIG. 4, a different point from the first embodiment is that the holder 4a for holding the thermistor 6 is disposed in the chamber 2e.

The chamber 2e, as described above, is provided to compressively deliver fuel to an injector surely without being affected by a change in fuel level even when the fuel level is changed due to a vehicle acceleration or deceleration when a small amount of fuel 8 remains in the fuel tank 9.

Consequently, the closer the thermistor 6 is brought to the bottom of the fuel tank 9, the more accuracy of detecting the remaining amount of fuel is enhanced and therefore fuel remaining in only the chamber 2e can be accurately detected by disposing the holder 4a in the chamber 2e.

In addition, in FIG. 4, the spring 7 is provided; however, in the case of fixing the holder 4a to the chamber 2e, it is preferable that the holder 4a is formed of metal and is similarly fixed to the bottom surface or one of the side surfaces of the metal chamber 2e by welding or the like when considered from the viewpoint of a sealing property of the chamber 2e. In this case, as described in the first embodiment, it is needless to say that the minus side terminal of the thermistor 6 is lead to the grounding terminal 2c via the holder 4a.

Third Embodiment

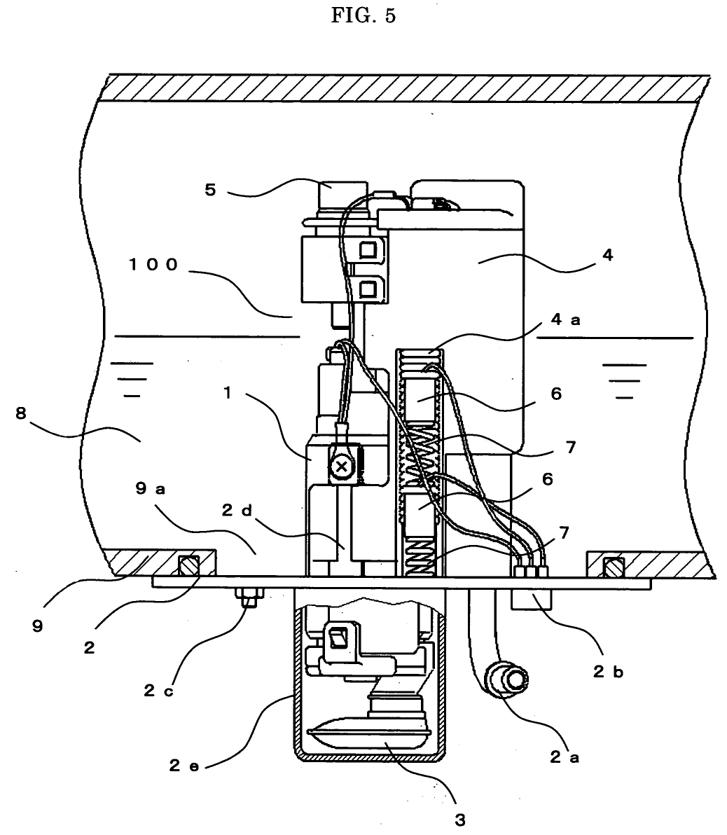

A third embodiment of the present invention will be described with reference to FIG. 5.

FIG. 5 is an outline view showing a fuel supply device according to the third embodiment of the present invention. In addition, referring to the drawing, the same reference numerals as those shown in FIG. 1 and FIG. 4 represent the same or corresponding elements and their description will be omitted.

In the aforementioned first embodiment, a plurality of the holders 4a with different elevations are provided as means for enhancing accuracy of detecting the remaining amount of fuel 8; however, in this case, spaces for disposing the plurality of the holders 4a are necessarily required. Consequently, the fuel supply device of the third embodiment is such that the holders 4 can be placed within one portion.

As shown in FIG. 5, the fuel supply device of the third embodiment is configured such that the holders 4 are placed within one portion where a plurality (two, in this case) of the thermistors 6 are held at positions with different elevations of the holder 4a.

According to the fuel supply device of the third embodiment, a plurality (two, in this case) of the thermistors 6 monitor the remaining amount of fuel, thereby enhancing accuracy of detecting the remaining amount of fuel 8 as is the case with the first embodiment and also enabling the fuel supply device 100 to be small because of the holder 4a being placed within one portion.

Although the present invention has been described on the basis of the first to the third embodiments, the present invention is not limited to these embodiments and it is needless to say that various changes and modifications will be possible within the scope of the present invention, for example, the fuel supply device 100 may be mounted from the upper surface side, not from the lower surface side, of the fuel tank 9.

What is claimed is:

1. A fuel supply device comprising:
a bracket attached to an opening of a fuel tank, for being arranged with a discharge pipe;
a fuel pump mounted to the bracket, for suctioning fuel in the fuel tank and discharging fuel from the discharge pipe; and
a fuel level detector for detecting the remaining amount of fuel in the fuel tank, the fuel supply device further comprising:
a holder for holding the fuel level detector, the holder being formed of an elastically deformable material and mounted on the bracket, and wherein
the fuel level detector is held at any position.

2. The fuel supply device according to claim 1, further comprising a filter case which accommodates a filter for filtering fuel discharged from the fuel pump and is mounted on the bracket, and wherein
the fuel level detector is held by a plurality of the holders which are formed at the filter case so that the fuel level detector is held at a plurality of positions at different elevations.

3. The fuel supply device according to claim 1, further comprising a fuel pump holding member with which the fuel pump is mounted to the bracket, and wherein
the fuel level detector is held by a plurality of the holders which are formed at the fuel pump holding member so that the fuel level detector is held at a plurality of positions at different elevations.

4. The fuel supply device according to claim 1, further comprising a chamber mounted to the bracket, for communicating with the fuel tank to store fuel, and wherein
the holder for holding the fuel level detector is fixed to the chamber.

5. The fuel supply device according to claim 1, wherein the holder for holding the fuel level detector is placed within one portion where a plurality of the fuel level detectors are held at positions with different elevations of the holder.

6. The fuel supply device according to claim 1, wherein
the fuel level detector is a thermistor and is grounded with a spring via the bracket.

7. The fuel supply device according to claim 1, wherein
the fuel level detector is a thermistor, and wherein the holder is conductive.

8. The fuel supply device according to claim 4, wherein
the fuel level detector is a thermistor and is grounded with a spring via the bracket.

9. The fuel supply device according to claim 4, wherein
the fuel level detector is a thermistor, and wherein the holder is conductive.

10. The fuel supply device according to claim 4, wherein
the fuel level detector is a thermistor and the thermistor is provided with a plurality numbers.

11. The fuel supply device according to claim 5, wherein
the fuel level detector is a thermistor and is grounded with a spring via the bracket.

12. The fuel supply device according to claim 5, wherein
the fuel level detector is a thermistor, and wherein the holder is conductive.
